(19) United States
(12) Patent Application Publication
(10) Pub. No.: US 2016/0152170 A1
(43) Pub. Date: Jun. 2, 2016

(54) RAMP SYSTEM

(71) Applicants: Bahadir HIZLAN, Kocaeli (TR); HEKSAGON MUHENDISLIK VE TASARIM ANONIM SIRKETI, Istanbul (TR)

(72) Inventors: Evrem KIYAK, Kocaeli (TR); Kadir EROL, Kocaeli (TR); Ozgür USTUN, Istanbul (TR); Ramazan Nejat TUNCAY, Istanbul (TR); Gurkan TOSUN, Istanbul (TR)

(73) Assignee: HEKSAGON MUHENDISLIK VE TASARIM ANONIM SIRKETI, Istanbul (TR)

(21) Appl. No.: 14/904,104

(22) PCT Filed: Jul. 15, 2014
(86) PCT No.: PCT/TR2014/000285

§ 371 Date: Jan. 10, 2016

(30) Foreign Application Priority Data
Aug. 1, 2013 (TR) 2013/09370

(51) Int. Cl. B60P 1/43; B65G 69/28

(52) U.S. Cl. CPC B60P 1/431; B65G 69/28

(57) ABSTRACT

The present invention relates to a ramp system (1) with linear motor drive, which is designed to enable the physically disabled to board and dismount from the vehicles, enables the disabled to board the vehicle from both sides of the vehicle, has a small packaging volume, and has a linear motor (4) that provides the movement of the ramp (2) when power is supplied.

### FIELD OF THE INVENTION

The present invention relates to a ramp system with linear motor drive, which is designed to enable the physically disabled and people with reduced mobility to board or dismount from the vehicles.

### BACKGROUND OF THE INVENTION

The mechanisms, which are designed to enable wheelchair-dependent physically disabled people, to board the vehicles, meet an important need in our day. Various mechanisms are designed to facilitate boarding of these people to vehicles with or without wheelchairs. Disabled individuals can easily board the vehicles by means of these mechanisms.

Today, the ramps for the disabled are generally operated by converting the rotational movement of the electric motor into linear movement that will be performed by the ramp. For this purpose, mechanical transmission means such as worm gear systems, rack-pinion gear, sheave-wire, belt-pulley systems and transmission equipments are used. Integration of these systems to vehicles causes packaging constraints. Furthermore, in many applications the ramp can only be extended towards one direction of the vehicle, thus it provides use only on one side. In this case, access to the ramp from the other side of the vehicle is not possible. Due to in-vehicle packaging constraints, the ramp can only serve as a telescopic structure. The telescopic structure increases mechanical complexity and may also cause weight and packaging problems.

Furthermore, placing the mechanical transmission system inside the vehicle causes limitations in the inner space of the vehicle and the volume of use decreases. Additionally, in conventional sliding ramp systems, moving the ramp manually poses serious problems when power is cut due to a malfunction. Because of the resistance of the mechanical transmission system, this can only be achieved as a result of a long process performed by a manifold.

Turkish Patent document no TR201009466, an application known in the state of the art, discloses a ramp mechanism (1) which comprises at least one ramp (2) which enables objects such as a wheelchair, a baby carriage or a wheel suitcase to have accessibility to interior and exterior of a vehicle and which can open to left and right sides of a vehicle, wherein the objects such as a wheelchair, a baby carriage or a wheel suitcase will get into the vehicle and get out of the vehicle by passing thereon; at least one body (3) which is fixed onto the vehicle floor and on which the ramp (2) moves; at least one motor (4) which provides actuation energy required to move the ramp (2).

### SUMMARY OF THE INVENTION

The objective of the present invention is to provide a ramp system which enables physically disabled individuals to board the vehicle from both sides of the vehicle.

Another objective of the present invention is to provide a ramp system, the packaging volume and weight of which is reduced by using a linear motor.

### BRIEF DESCRIPTION OF THE DRAWINGS

A ramp system developed to fulfill the objective of the present invention is illustrated in the accompanying figures, in which,

FIG. 1 is the side view of a ramp system.

FIG. 2 is the perspective view of a ramp system.

FIG. 3 is the perspective view of a ramp system from another angle.

FIG. 4 is the perspective view of a ramp system which is mounted on the vehicle.

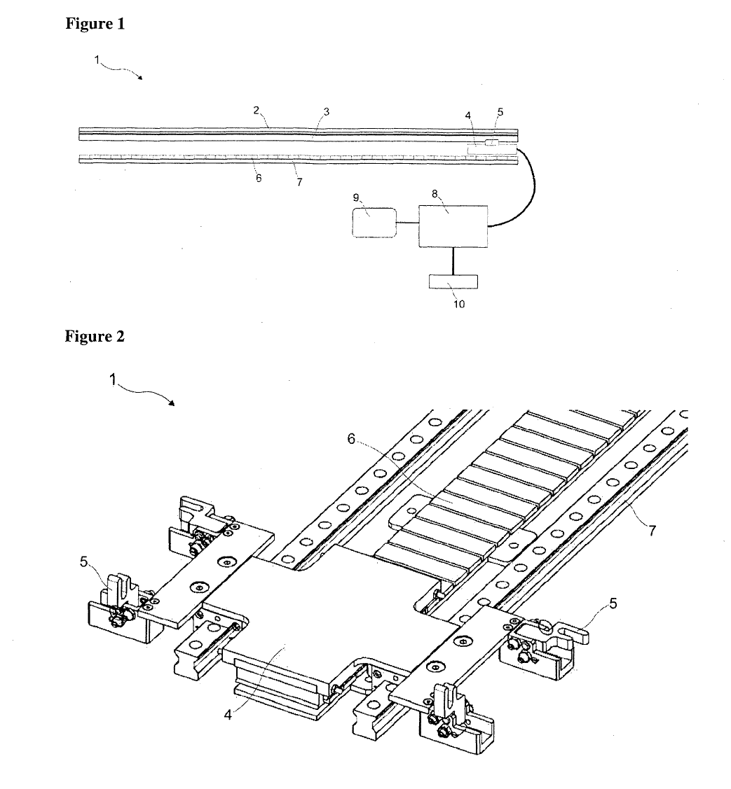

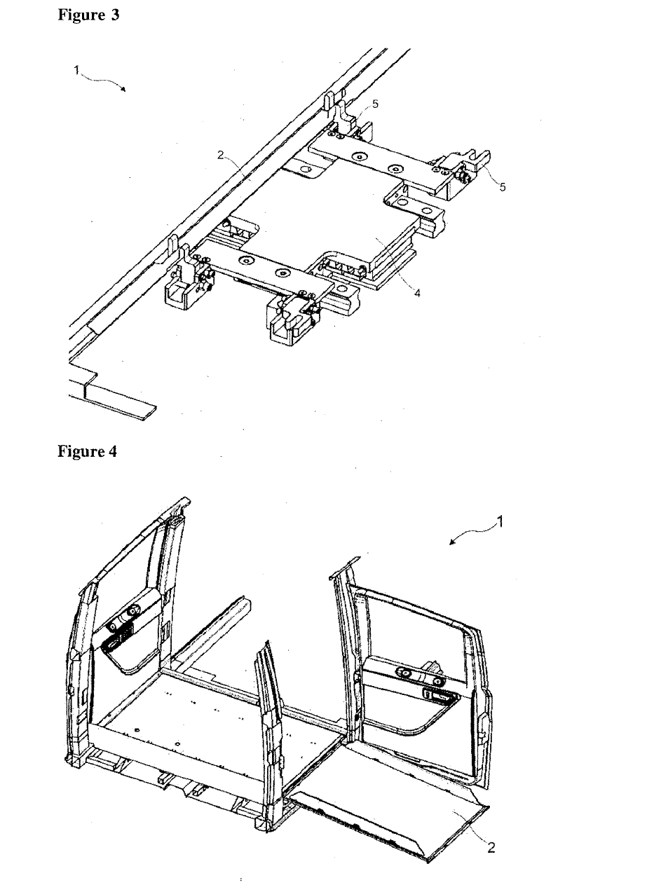

The components shown in the figures are each given reference numbers as follows:
11. Ramp system
12. Ramp
13. Linear guide
14. Linear motor
15. Lock
16. Magnet
17. Base
18. Control unit
19. Remote control
20. Power supply

### DETAIL DESCRIPTION OF THE INVENTION

A ramp system (1) with a linear motor chive, which is designed to enable the physically disabled to board and dismount from the vehicles, enables the disabled to board the vehicle from both sides of the vehicle, and has a small packaging volume, essentially comprises
at least one ramp (2) which extends from both sides of the vehicle and enables the wheelchair to easily board and dismount from the vehicle,
at least one linear guide (3) which is positioned to enable movement of the ramp (2),
at least one linear motor (4) which enables linear movement of the ramp (2) thanks to linear drive,
at least one lock (5) which provides the connection of the ramp (2) with the linear motor (4),
at least one magnet (6) which enables the linear motor (4) to move on a certain plane,
at least one base (7) on which the magnets (6) are positioned,
at least one control unit (8) which enables the power supplied to the magnets (6) to he transmitted when preferred,
at least one remote control (9) which enables the control unit (8) to be controlled by the user,
at least one power supply (10) which supplies power to the control unit (8).

In one embodiment of the invention, the ramp (2), which can extend from both sides of the vehicle and which thus provides ease of use in both directions, is located on the linear guide (3). The linear motor (4) is located on the lower part of the linear guide (3). Connection of the linear motor (4) with the ramp (2) is provided by the locks (5). By means of the said locks (5) that are located on each corner of the linear motor (4), the ramp (2) can be moved in preferred direction of the vehicle. In cases wherein the ramp (2) is required to be extended towards the right side of the vehicle, the locks (5) located on the right side of the linear motor (4) hold the ramp (2), and the linear motor (4) slides the ramp (2) towards the right side. Besides, when the ramp (2) is preferred to be extended towards the left side of the vehicle, the locks (5) located on the left side of the linear motor (4) hold the ramp (2), and the linear motor (4) slides the ramp (2) towards the left side of the vehicle. The linear movement of the linear motor (4) is realized by the interaction of the magnet (6) located on the base (7) with the linear motor (4) The power supplied to the magnet (6) is controlled by the control unit (8). The control unit (8) determines in which direction the linear motor (4) will move by supplying power to the magnet (6) when preferred. The drive for the control unit (8) is provided by means of a remote control (9). The power of the control unit (8) is obtained from the power supply (10).

The operation of the ramp system (1) is as follows: In the initial position, the ramp (2) is in a concealed position under the lower part of the vehicle. When the ramp (2) is in this position, the user sends a command to the control unit (8) via the remote control (9). Upon this command, the control unit (8) sends a command to the locks (5), which are located on the linear motor (4) and which will hold the ramp (2), and enables the said locks (5) to hold the ramp (2). Besides, the control unit (8) determines in which direction power will he supplied to the magnets (6) and supplies power thereto. After power is supplied to the magnets (6), the linear motor (4) moves, and moves the ramp (2) in the direction determined with the command given by the user via the remote control (9). By this means, the ramp (2) extends from the right or left side of the vehicle, and contacts the ground after a while. When the contact of the ramp (2) with the ground is provided, its movement stops and it becomes ready to use. When the user boards the vehicle, the linear motor (4) moves in the direction opposite to its first movement and thus enables the ramp (2) to be placed back into the vehicle.

1. A ramp system with a linear motor drive which is designed to enable a physically disabled to board and dismount from vehicles, and enables the disabled to board the vehicle from both sides of the vehicle and has a small packaging volume, comprising:
at least one ramp which extends from both sides of the vehicle and enables a wheelchair to easily board and dismount from the vehicle;
at least one linear motor which enables a linear movement of the ramp thanks to linear drive.

2. The ramp system according to claim 1, wherein at least one lock provides the connection of the ramp with the linear motor.

3. The ramp system according to claim 1, wherein at least one magnet enables the linear motor to move on a certain plane.

4. The ramp system according to claim 1, wherein at least one control unit enables the power supplied to the magnets to be transmitted when preferred.

5. The ramp system according to claim 1, wherein at least one remote control enables the control unit to be controlled by a user.

6. The ramp system according to claim 1, wherein at least one linear guide is positioned to enable movement of the ramp.

7. The ramp system according to claim 1, wherein the magnets are positioned on at least one base.

8. The ramp system according to claim 1, wherein at least one power supply supplies power to the control unit.

9. The ramp system according to claim 1, wherein the ramp can extend from both sides of the vehicle and thus provides ease of use in both directions.

10. The ramp system according to claim 1, wherein the linear motor is located on the lower part of the linear guide and the connection of which with the ramp is provided by means of a plurality of locks.

11. The ramp system to claim 1, wherein the lock enables the ramp to be moved in a preferred direction of the vehicle thanks to being located on each corner of the linear motor.

12. The ramp system according to claim 1, wherein the ramp is held by the locks located on the right side of the linear in cases and is required to be extended towards the right side of the vehicle.

13. The ramp system according to claim 1, wherein the ramp is held by the locks located on the left side of the linear motor in cases and is preferred to be extended towards the left side of the vehicle.

14. The ramp system according to claim 1, wherein the linear movement of the linear motor is realized by the interaction with the magnet located on the base.

15. The ramp system according to claim 1, wherein the power of the magnet is controlled by the control unit.

16. The ramp system according to claim 1, wherein the control unit determines in which direction the linear motor will move by supplying power to the magnet when preferred and the drive of which is provided by means of the remote control.

17. The ramp system according to claim 1, wherein the control unit sends a command to the locks which are located on the linear motor and which will hold the ramp, and enables the said locks to hold the ramp.

18. The ramp system according to claim 1, wherein the control unit determines in which direction power will be supplied to the magnets and supplies power thereto.

19. The ramp system according to claim 1, wherein the linear motor which moves after power is supplied to the magnets moves the ramp in the direction determined by the command given by the user via the remote control.

20. The ramp system according to claim 1, wherein the ramp extends from the right or left side of the vehicle and contacts the ground after a while, wherein the movement of the ramp stops when the contact with the ground is provided, and becomes ready to use.

21. The ramp system according to claim 1, wherein the linear motor moves in the direction opposite to the first movement of the linear motor when the user boards the vehicle, and thus enables the ramp to be placed back into the vehicle.
